(19) United States
(12) Patent Application Publication
(10) Pub. No.: US 2024/0393861 A1
(43) Pub. Date: Nov. 28, 2024

(54) SHADER COMPILER AND SHADER PROGRAM CENTRIC MITIGATION OF CURRENT TRANSIENTS THAT CAUSE VOLTAGE TRANSIENTS ON A POWER RAIL

(71) Applicants: Advanced Micro Devices, Inc., Santa Clara, CA (US); ATI Technologies ULC, Markham (CA)

(72) Inventors: Josip Popovic, Markham (CA); Rashad Oreifej, Orlando, FL (US); Robert Alan Marc Gottlieb, Boxborough, MA (US)

(21) Appl. No.: 18/540,703

(22) Filed: Dec. 14, 2023

Related U.S. Application Data
(60) Provisional application No. 63/504,687, filed on May 26, 2023.

(51) Int. Cl. G06F 1/3296; G06T 15/00

(52) U.S. Cl. CPC G06F 1/3296; G06T 15/005

(57) ABSTRACT

An apparatus and method for efficiently managing voltage transients on a power rail caused by current transients of an integrated circuit. In various implementations, a computing system includes a processing circuit that executes instructions of a compiler that includes a current transients mitigator. When executing the instructions of the current transients mitigator, the processing circuit generates an estimate of a time rate of current flow being drawn from or returned to the power rail based on instruction types of a first sequence of instructions. Based on the estimate exceeds a threshold, the processing circuit replaces the first sequence of instructions with a second sequence of instructions that provides a smaller estimate. The second sequence is issued to the one or more compute circuits that utilize the power rail, rather than the first sequence.

### CROSS REFERENCE TO RELATED APPLICATIONS

This application claims priority to Provisional Patent Application Ser. No. 63/504,687, entitled “SHADER COMPILER AND SHADER PROGRAM MITIGATION OF UNDERSHOOT AND OVERSHOOT ON A POWER RAIL”, filed May 26, 2023, the entirety of which is incorporated herein by reference.

### BACKGROUND

### Description of the Relevant Art

Current transients on a power rail of an integrated circuit include a time rate of current flow being drawn from or returned to the power rail. Large current transients include a large amount of current being drawn from or returned to the power rail in a relatively short amount of time. Large current transients on the power rail cause large voltage transients on the power rail. This voltage transient, ΔV, is proportional to the expression L di/dt. Here, the term “L” is the parasitic inductance of the power delivery network that includes the power rail corresponding to the supply pin. The term “di/dt” is the time rate of change of the current consumption. Large voltage transients of modern integrated circuits have become an increasing design issue with each generation of semiconductor chips. These appreciable voltage transients on the power rail caused by the current transients are not only an issue for portable computers and mobile communication devices, but also for desktops and servers.

Besides adjusting the operational clock frequency, another manner to reduce the voltage transients on the power rail caused by the current transients is the placement of capacitors. Placing one or more of external capacitors between the supply leads and an on-chip capacitor between the internal supply leads reduces the voltage transients on the power rail. Each of these capacitances creates a passive bypass that reduces the supply line oscillation due to one of external or internal inductances, but not both of the inductances. In addition, the internal capacitor is very large, which requires a significant portion of the chip area. This manner is undesirable when minimization of the die area is needed.

In view of the above, methods and systems for efficiently managing current transients that cause voltage transients on a power rail of an integrated circuit are desired.

### BRIEF DESCRIPTION OF THE DRAWINGS

FIG. 1 is a generalized block diagram of a computing system that mitigates current transients that cause voltage transients on a power rail of an integrated circuit.

FIG. 2 is a generalized block diagram of signal waveforms that illustrates mitigation of current transients that cause voltage transients on a power rail of an integrated circuit.

FIG. 3 is a generalized block diagram of signal waveforms that illustrates mitigation of current transients that cause voltage transients on a power rail of an integrated circuit.

FIG. 4 is a generalized block of command sequences that illustrate modifications that reduce current transients that cause voltage transients on a power rail of an integrated circuit.

FIG. 5 is a generalized block diagram of command sequences that illustrate modifications that reduce current transients that cause voltage transients on a power rail of an integrated circuit.

FIG. 6 is a generalized block diagram of an apparatus that mitigates current transients that cause voltage transients on a power rail of an integrated circuit.

FIG. 7 is a generalized block diagram of a method for efficiently managing voltage transients on a power rail caused by current transients of an integrated circuit.

FIG. 8 is a generalized block diagram of a method for efficiently managing voltage transients on a power rail caused by current transients of an integrated circuit.

FIG. 9 is a generalized block diagram of a method for efficiently managing voltage transients on a power rail caused by current transients of an integrated circuit.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods efficiently mitigating voltage transients on a power rail caused by current transients of an integrated circuit are contemplated. In various implementations, a computing system includes a first processing circuit and a second processing circuit. In some implementations, the first processing circuit has a general-purpose microarchitecture and the second processing circuit is a parallel data processing circuit with a highly parallel data microarchitecture. The parallel data processing circuit includes multiple, replicated compute circuits, each with the circuitry of multiple lanes of execution. In some implementations, one or more of the compute circuits receive a power supply voltage from a particular power rail. The first processing circuit accesses a copy of an application. When the circuitry of the first processing circuit executes instructions of a compiler, the first processing circuit translates the source code of the application to a lower-level representation and then to machine code.

The compiler includes a current transients mitigator. When the circuitry of the first processing circuit executes instructions of the current transients mitigator, the first processing circuit modifies a first sequence of instructions (or translated commands) to create a second sequence of instructions (or translated commands) by adding one or more new instructions in the first sequence of instructions. The first processing circuit performs the modification based on determining that the first sequence of instructions meets a power related condition such as determining that the first sequence of instructions includes a count of consecutive high-power instructions that exceeds a count threshold. The first processing circuit compiles the generated second sequence of instructions into machine executable code for execution by processing circuitry such as circuitry of the compute circuits of the second processing circuit. In an implementation, the application is a highly parallel data application, such as a shader program, and the compiler is a shader compiler.

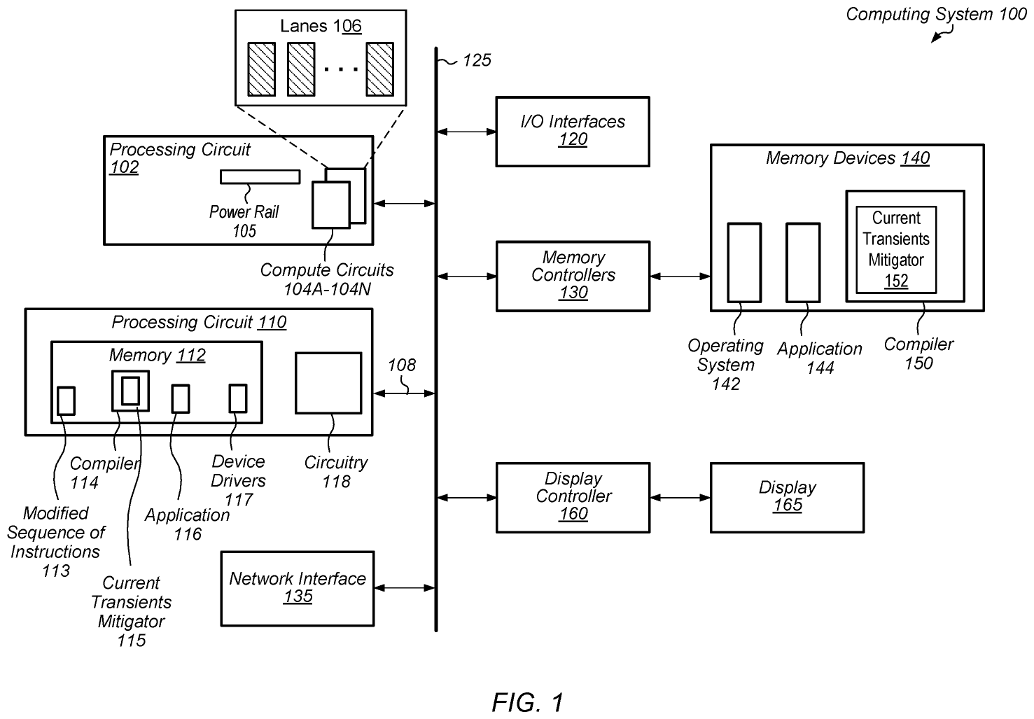

Later, a scheduler issues the second sequence of instructions, rather than the first sequence of instructions, to the one or more compute circuits that utilize the power rail. Therefore, when the first processing circuit executes instructions of the current transients mitigator of the compiler, the first processing circuit modifies the instructions of the application machine code to reduce a sudden, large change in the time rate of change of the current flow, di/dt, either returned to or drawn from the power rail utilized by the one or more compute circuits of the second processing circuit. When the first processing circuit executes instructions of the current transients mitigator of the compiler, the first processing circuit provides proactive mitigation of power supply voltage transients on the power rail caused by current transients. Further details of these techniques to reduce the voltage transients on a power rail caused by current transients of an integrated circuit are provided in the following description of FIGS. 1-9.

Turning now to FIG. 1, a generalized diagram is shown of an implementation of a computing system 100 that mitigates current transients that cause voltage transients on a power rail of an integrated circuit. In an implementation, the computing system 100 includes at least processing circuits 102 and 110, input/output (I/O) interfaces 120, bus 125, network interface 135, memory controllers 130, memory devices 140, display controller 160, and display 165. Processing circuits 102 and 110 are representative of any number of processing circuits which are included in computing system 100. In other implementations, computing system 100 includes other components and/or computing system 100 is arranged differently. For example, power management circuitry, and phased locked loops (PLLs) or other clock generating circuitry are not shown for ease of illustration. In various implementations, the components of the computing system 100 are on a same die such as a system-on-a-chip (SOC). In other implementations, the components are individual dies in a system-in-package (SiP) or a multi-chip module (MCM). A variety of computing devices use the computing system 100 such as a desktop computer, a laptop computer, a server computer, a tablet computer, a smartphone, a gaming device, a smartwatch, and so on.

In one implementation, the processing circuit 102 is a parallel data processing circuit with a highly parallel data microarchitecture, such as a graphics processing unit (GPU). The processing circuit 102 can be a discrete device, such as a dedicated GPU (dGPU), or the processing circuit 102 can be integrated (an iGPU) in the same package as another processing circuit. In an implementation, the other processing circuit is the processing circuit 110, which can be a central processing unit (CPU). Other parallel data processing circuits that can be included in computing system 100 include digital signal processing circuits (DSPs), field programmable gate arrays (FPGAs), application specific integrated circuits (ASICs), and so forth.

In various implementations, the processing circuit 102 includes multiple compute circuits 104A-104N, each including similar circuitry and components such as the multiple, parallel computational lanes 106. One or more of the compute circuits 104A-104N share a power rail 105. Current transients on the power rail 105 of the processing circuit 102 include a time rate of current flow being drawn from or returned to the power rail 105. Large current transients include a large amount of current being drawn from or returned to the power rail 105 in a relatively short amount of time. Large current transients on the power rail 105 cause large voltage transients on the power rail 105.

In some implementations, the parallel computational lanes 106 (or lanes 106) operate in lockstep. In various implementations, the data flow within each of the lanes 106 is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across the lanes 106 includes the same circuitry and functionality, and operates on a same instruction, but different data associated with a different thread. A particular combination of the same instruction and a particular data item of multiple data items is referred to as a “work item.” A work item is also referred to as a thread.

The multiple work items (or multiple threads) are grouped into thread groups, where a “thread group” is a partition of work executed in an atomic manner. In some implementations, a thread group includes instructions of a function call that operate on multiple data items concurrently. Each data item is processed independently of other data items, but the same sequence of operations of the subroutine is used. As used herein, a “thread group” is also referred to as a “work block” or a “wavefront.” Tasks performed by the parallel data processing circuit 102 can be grouped into a “workgroup” that includes multiple thread groups (or multiple wavefronts). The hardware, such as circuitry, of a scheduler divides the workgroup into separate thread groups (or separate wavefronts), and assigns the thread groups to the compute circuits 104A-104N. In an implementation, a workgroup includes 8 wavefronts, one for each of eight compute circuits 104A-104N, and a wavefront includes 64 threads, one for each lane of the 64 lanes of the multiple lanes 106 of the compute circuits 104A-104N. In other implementations, another number of threads and wavefronts are used based on the hardware configuration of the parallel data processing circuit 102.

Although an example of a single instruction multiple data (SIMD) microarchitecture is shown for the compute circuits 104A-104N, other types of highly parallel data micro-architectures are possible and contemplated. The high parallelism offered by the hardware of the compute circuits 104A-104N is used for real-time data processing. Examples of the real-time data processing are rendering multiple pixels, image blending, pixel shading, vertex shading, and geometry shading. In such cases, each of the data items of a wave front is a pixel of an image. The compute circuits 104A-104N can also be used to execute other threads that require operating simultaneously with a relatively high number of different data elements (or data items). Examples of these threads are threads for scientific, medical, finance and encryption/decryption computations.

In one implementation, the processing circuit 110 is a general-purpose processing circuit, such as a central processing unit (CPU), with any number of processing circuit cores that include circuitry for executing program instructions. Memory 112 represents a local hierarchical cache memory subsystem. Memory 112 stores source data, intermediate results data, results data, and copies of data and instructions stored in memory devices 140. For example, the memory 112 stores the compiler 114 and the application 116, which are copies of the compiler 150 and the application 144 stored in the memory devices 140. Processing circuit 110 is coupled to bus 125 via interface 108. Processing circuit 110 receives, via interface 106, copies of various data and instructions, such as shader programs, the operating system 142, one or more device drivers, one or more applications such as application 144, and/or other data and instructions.

The processing circuit 110 retrieves a copy of the compiler 150 from the memory devices 140, and the processing circuit 110 stores this copy as compiler 114 in memory 112. The compiler 114 includes the current transients mitigator 115, which is a copy of the current transients mitigator 152. The processing circuit 110 retrieves a copy of the application 144 from the memory devices 140, and the processing circuit 110 stores this copy as application 116 in memory 112. One example of the application 116 is a highly parallel data application such as a shader program. When the instructions of the compiler 114 are executed by the circuitry 118, the circuitry 118 compiles the application 116. As part of the compiling, the circuitry 118 translates instructions of the application 116 into commands executable by the compute circuits 104A-104N of the processing circuit 102. For example, when the instructions of the compiler 114 are executed by the circuitry 118, the circuitry 118 uses a graphics library with its own application program interface (API) to translate function calls of the application 116 into commands particular to the compute circuits 104A-104N of the processing circuit 102.

To change the scheduling of threads from the processing circuit 110 to the processing circuit 102, software development kits (SDKs) and application programming interfaces (APIs) were developed for use with widely available high-level languages to provide supported function calls. The function calls provide an abstraction layer of the parallel implementation details of the processing circuit 102 such as the lanes 106 of the compute circuits 104A-104N. The details are hardware specific to the parallel data processing circuit 102 but hidden to the developer to allow for more flexible writing of software applications. The function calls in high level languages, such as C, C++, FORTRAN, and Java and so on, are translated to commands which are later processed by the hardware in the processing circuit 102.

Platforms such as OpenCL (Open Computing Language), OpenGL (Open Graphics Library), OpenGL for Embedded Systems (OpenGL ES), and Vulkan provide a variety of APIs for running programs on GPUs from AMD, Inc. Developers use OpenCL for simultaneously processing the multiple data elements of the scientific, medical, finance, encryption/decryption and other computations while using OpenGL and OpenGL ES for simultaneously rendering multiple pixels for video graphics computations. Vulkan is a low-overhead, cross-platform API, open standard for three-dimensional (3-D or 3D) graphics applications. Further, DirectX is a platform for running programs on GPUs in systems using one of a variety of Microsoft operating systems.

During compiling of the application 116, when the instructions of the current transients mitigator 115 are executed by the circuitry 118, the circuitry 118 modifies a first sequence of instructions (or translated commands) to create a second sequence of instructions (or translated commands) by adding one or more new instructions in the first sequence of instructions. An example of the second sequence of instructions is the modified sequence of instructions 113 stored in memory 112. The modified sequence of instructions 113 is stored in the memory 112 as part of a compiled application. When the circuitry 118 executes the instructions of the current transients mitigator 115, the circuitry 118 performs the modification based on determining that the first sequence of instructions meets a power related condition. An example of determining that the first sequence of instructions meets the power related condition is determining that the first sequence of instructions includes a count of consecutive high-power instructions that exceeds a count threshold. When circuitry 118 executes the instructions of the compiler 114, the circuitry 118 compiles the generated second sequence of instructions into machine executable code for execution by processing circuitry. An example of the processing circuitry is a GPU such as the compute circuits 104A-104N of the processing circuit 102.

In various implementations, when the circuitry 118 executes the instructions of the current transients mitigator 115, the circuitry 118 categorizes translated commands of a sequence of instructions of the application 116 into power bins. The power bins provide an estimated (predicted) power consumption of the commands, or an estimated (predicted) time rate of change of current transferred between the power rail 105 and one or more of the compute circuits 104A-104N that rely on the power rail 105 for a power supply voltage. In some implementations, the granularity of the estimations (or predictions) of power consumption is less than the number of different opcodes of the commands. Rather, the current transients mitigator circuit 115 supports a particular number of categories, which are also referred to as “power bins.” In an implementation, the current transients mitigator 115 supports 4 power bins, and each of the commands belongs to one of the 4 power bins based on one or more of the opcodes of the commands, the number and size of operands used by the commands, the operating parameters being used by the compute circuits 104A-104N, a measured operating temperature of the integrated circuit, and so forth.

Each power bin has an associated number of power credits. A “power credit” can also be referred to as a “power signature.” A number of power credits of a particular power bin indicates the amount of power consumed (or the amount of current flow being drawn from or returned to a shared power rail) when a command with an opcode corresponding to the particular power bin is executed by one of the compute circuits 104A-104N. Both the absolute values and the relative values of the power signatures among the different power bins can be assigned based on testing of the processing circuit 102 in a lab environment, circuit simulations prior to semiconductor fabrication, or a combination of the two methods.

When the circuitry 118 executes the instructions of the current transients mitigator 115, the circuitry 118 modifies the commands to generate the modified sequence of instructions 113 that reduces the estimated (predicted) time rate of change of the power consumption of the commands. The modification is based on the characterizing of the commands with the power bins. In some implementations, the circuitry 118 also assigns the modified sequence of instructions 113 to particular compute circuits of the compute circuits 104A-104N of the processing circuit 102.

In an implementation, when the circuitry 118 executes the instructions of the current transients mitigator 115, the circuitry 118 generates the modified sequence of instructions 113 by inserting, in program order, a low-power instruction after a particular instruction of the first sequence of instructions being evaluated. A low-power instruction belongs to a power bin that provides an estimated (predicted) power consumption below a threshold. The instruction sequence modifier 642 inserts, as the low-power instruction, an instruction with a type associated with low power consumption and does not change program execution state information. For example, the inserted low-power instruction does not change an outcome of an application that includes the first sequence of instructions. An example of this low-power instruction is a nop instruction, although various other instruction types can also be used.

In an implementation, the circuitry 118 inserts, as the low-power instruction, a nop instruction. In another implementation, the circuitry 118 inserts, as the low-power instruction, a move instruction that includes a destination operand that matches a source operand. In yet another an implementation, the circuitry 118 inserts, as the low-power instruction, Boolean arithmetic instruction that generates a destination result that matches a value of a source operand. Other examples of low-power instructions to insert that do not change program execution state information are possible and contemplated.

In an implementation, when executing instructions of a kernel mode driver (KMD), the circuitry 118 assigns state information for a command group that includes at least the modified sequence of instructions 113 generated by compiling the application 116. Examples of the state information are a process identifier (ID), a name of the application or an ID of the application, a version of the application, a compute/graphics type of work, and so on. When executing instructions of the kernel mode driver, the circuitry 118 sends the command group and state information to a ring buffer 112 in the memory devices 140. The processing circuit 102 accesses, via the memory controllers 130, the command group and state information stored in the ring buffer.

The processing circuit 102 schedules the retrieved commands to the compute circuits 104A-104N based on at least the state information. Other examples of scheduling information used to schedule the retrieved commands are age of the commands, priority levels of the commands, an indication of real-time data processing of the commands, and so forth. Besides the kernel mode driver (KMD), the computing system 100 uses other device drivers (drivers) 117 of a driver stack during the compilation and execution of the application 144. The driver stack allows each driver to specialize in a particular type of function and decouples it from having to know about other drivers. Examples of the other drivers are user mode drivers, an input/output (I/O) interface of the operation system 142, and a file system driver.

In some implementations, computing system 100 utilizes a communication fabric (“fabric”), rather than the bus 125, for transferring requests, responses, and messages between the processing circuits 102 and 110, the I/O interfaces 120, the memory controllers 130, the network interface 135, and the display controller 150. When messages include requests for obtaining targeted data, the circuitry of interfaces within the components of computing system 100 translates target addresses of requested data. In some implementations, the bus 125, or a fabric, includes circuitry for supporting communication, data transmission, network protocols, address formats, interface signals and synchronous/asynchronous clock domain usage for routing data.

Memory controllers 130 are representative of any number and type of memory controllers accessible by processing circuits 102 and 110. While memory controllers 130 are shown as being separate from processing circuits 102 and 110, it should be understood that this merely represents one possible implementation. In other implementations, one of memory controllers 130 is embedded within one or more of processing circuits 102 and 110 or it is located on the same semiconductor die as one or more of processing circuits 102 and 110. Memory controllers 130 are coupled to any number and type of memory devices 140.

Memory devices 140 are representative of any number and type of memory devices. For example, the type of memory in memory devices 140 includes Dynamic Random Access Memory (DRAM), Static Random Access Memory (SRAM), NAND Flash memory, NOR flash memory, Ferroelectric Random Access Memory (FeRAM), or otherwise. Memory devices 140 store at least instructions of an operating system 142, one or more device drivers, and application 144. In some implementations, the application 144 is a highly parallel data application such as a video graphics application, a shader application, or other. Copies of these instructions can be stored in a memory or cache device local to processing circuit 110 and/or processing circuit 112.

I/O interfaces 120 are representative of any number and type of I/O interfaces (e.g., peripheral component interconnect (PCI) bus, PCI-Extended (PCI-X), PCIE (PCI Express) bus, gigabit Ethernet (GBE) bus, universal serial bus (USB)). Various types of peripheral devices (not shown) are coupled to I/O interfaces 120. Such peripheral devices include (but are not limited to) displays, keyboards, mice, printers, scanners, joysticks or other types of game controllers, media recording devices, external storage devices, and so forth. Network interface 135 receives and sends network messages across a network.

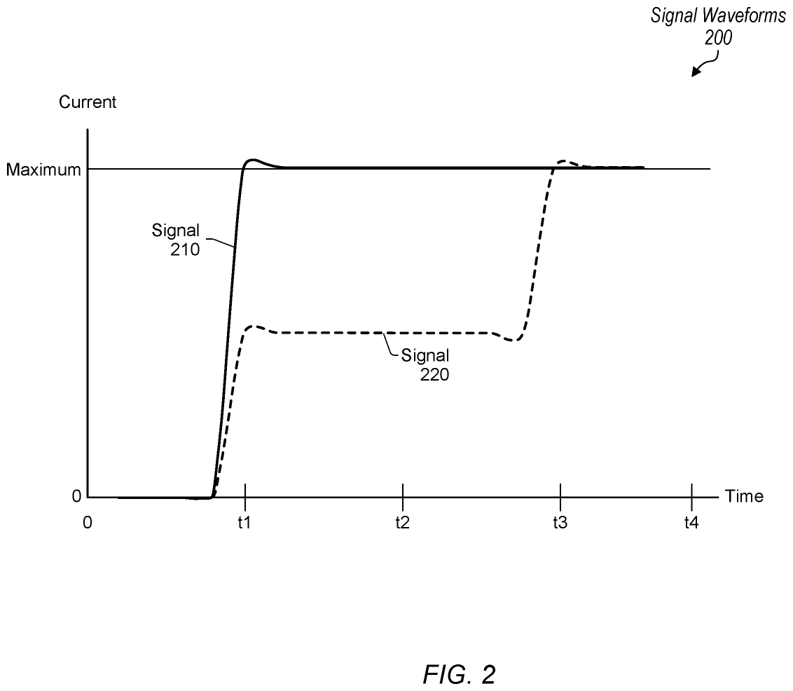

Turning now to FIG. 2, a generalized block diagram is shown of signal waveforms 200 that illustrates mitigation of current transients that cause voltage transients on a power rail of an integrated circuit. The signal waveforms 200 include the signal waveforms 210 and 220 indicating current drawn from a power rail over time. An example of the power rail is the power rail 105 in the processing circuit 105 (of FIG. 1). The current is measured generally within a range between no amperes and a maximum amount of current in amperes. Time is generally measured from 0 to a point in time t4 (or time t4) where each point in time indicates a particular duration. The particular duration is measured as a number of clock cycles or other measurement of time duration. The signal waveform 210 illustrates sudden current transients of the power rail, whereas the signal waveform 220 illustrates gradual current transients of the power rail.

If a large number of nodes in addition to buses switched simultaneously, a significant voltage drop on the power rail occurs. For example, if a large number of nodes of the compute circuits 104A-104N (of FIG. 1) switched simultaneously while executing the translated commands of a shader application, then a significant voltage drop can occur on the power rail 105. The near simultaneous charging of a large number of nodes, even nodes other than nodes of buses, of an integrated circuit consumes a large amount of the power supply current from the power rail. In such a case, the time rate of change of the current consumption, di/dt, is positive and large as shown in the signal waveform 210. The voltage transient, ΔV, is proportional to the expression L di/dt, wherein L is the parasitic inductance and di/dt is the time rate of change of the current consumption. When the current consumption, di/dt, is positive and large on the power rail, the voltage transients, ΔV, increase. The voltage transients, ΔV, is the difference between the initial voltage and the final voltage. Therefore, in this case, the difference, ΔV, is a large positive value, and the final voltage is less than the initial voltage.

The power supply voltage level on the power rail reduces as the amount of power supply current being drawn from the power rail increases. Now a node that holds a logic high value experiences a voltage drop that reduces its voltage value below a minimum threshold. For memories and latches without recovery circuitry, stored values are lost. Additionally, the switching speeds of devices (transistors) reduce, which reduces performance. The operating clock frequency needs to reduce to allow the setup time to be satisfied of sequential elements. However, in contrast to reducing the operating clock frequency, the translated commands can include modified commands, such as the modified sequence of instructions 113 (of FIG. 1), that were generated by the circuitry 118 executing the instructions of the current transients mitigator 115. In such a case, the current transients appear more like the signal waveform 220 than the signal waveform 210. The signal waveform 220 shows the corresponding circuitry does not lose data values due to voltage transients or have setup times of sequential circuitry affected by voltage transients caused by the corresponding current transients.

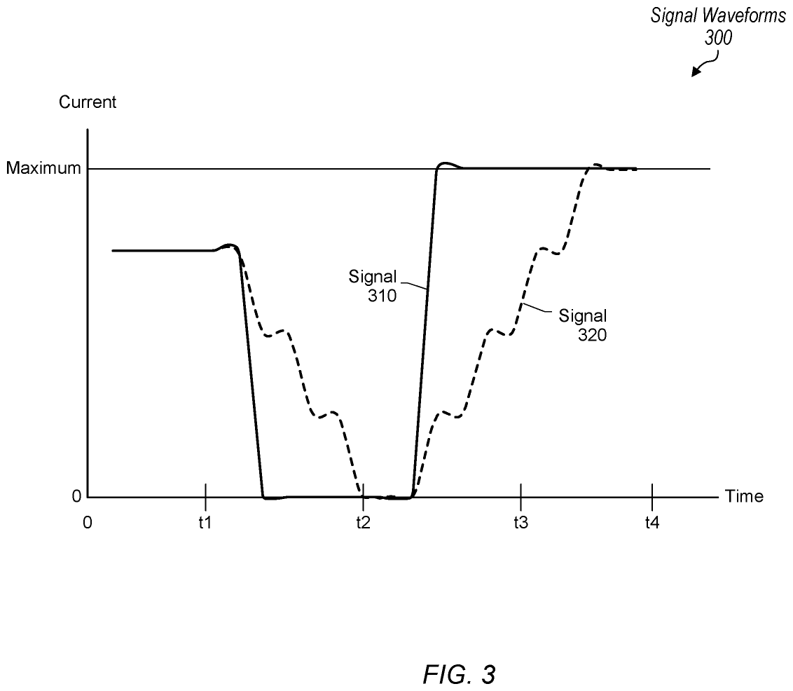

Referring to FIG. 3, a generalized block diagram is shown of signal waveforms 300 that illustrates mitigation of current transients that cause voltage transients on a power rail of an integrated circuit. The signal waveforms 300 include the signal waveforms 310 and 320 indicating current being returned to and being drawn from a power rail over time. The signal waveform 310 illustrates sudden current transients of the power rail, whereas the signal waveform 320 illustrates gradual current transients of the shared power rail. An example of the power rail is the power rail 105 in the processing circuit 105 (of FIG. 1). The signal waveform 310 illustrates sudden current transients of the power rail. The near simultaneous discharging of a large number of nodes, even nodes other than nodes of buses, of an integrated circuit can return a large amount of the power supply current to the power rail. For example, if a large number of nodes of the compute circuits 104A-104N (of FIG. 1) discharged simultaneously while executing the translated commands of an application, such as a shader application, then a significant amount of current is returned to the power rail 105.

Suddenly returning a large amount of current to the power rail causes the time rate of change of the current consumption, di/dt, to be negative and large. The voltage transient, ΔV, is proportional to the expression L di/dt. The voltage transient, ΔV, is the difference between the initial voltage and the final voltage of the power rail during a particular duration of time. Therefore, the difference, ΔV, is a large negative value. Consequently, the final voltage is greater than the initial voltage. The power supply voltage level on the power rail increases as the amount of power supply current being returned to the power rail increases.

As a result of the power supply voltage level on the power rail increasing, the switching speeds of devices increase, which increases performance. The device latencies decrease, and as a result, it is possible that a receiving sequential element does not have sufficient time to capture the incoming data prior to a capturing clock edge. This condition causes a hold time violation. One or more of a variety of hold time violation solutions can be applied such as at least decreasing the operating clock frequency. However, in contrast to performing one or more of the hold time violation solutions, the translated commands can include modified commands, such as the modified sequence of instructions 113 (of FIG. 1), that were generated by the circuitry 118 executing the instructions of the current transients mitigator 115. In such a case, the current transients appear more like the signal waveform 320 than the signal waveform 310.

Voltage transients (positive or negative) of a power rail occur when the workload transitions from light to heavy, or vice-versa, in a relatively short amount of time. As described earlier, the voltage transients are caused by the relatively sudden current transients, or a rate of change of the amount of current drawn from or returned to the power rail. Suddenly returning a large amount of the power supply current to the power rail in a relatively short amount of time causes a condition referred to as “overshoot.” Due to the current transients that have not been mitigated, the overshoot condition includes the final voltage of the shared power rail being greater than the initial voltage of the shared power rail by more than a threshold voltage difference. Voltage transients are non-zero differences between the initial voltage and the final voltage of the shared power rail during a particular duration of time. As described earlier, the voltage transient, ΔV, is proportional to the expression L di/dt. The overshoot condition occurs when the workload transitions from heavy to light in a relatively short amount of time.

In contrast, suddenly drawing a large amount of the power supply current from the shared power rail in a relatively short amount of time causes a condition referred to as “undershoot.” Due to the current transients that have not been mitigated, the undershoot condition includes the final voltage of the shared power rail being less than the initial voltage of the shared power rail by more than a threshold voltage difference. The undershoot condition occurs when the workload transitions from light to heavy in a relatively short amount of time. The undershoot condition is also referred to as “voltage droop.” When processing circuitry executes instructions of a current transients mitigator of a compiler, such as the current transients mitigator 115 (of FIG. 1), each of the current transients and the resulting voltage transients on the power rail are reduced. This reduction is shown in the signal waveform 320, which illustrates gradual current transients of the shared power rail.

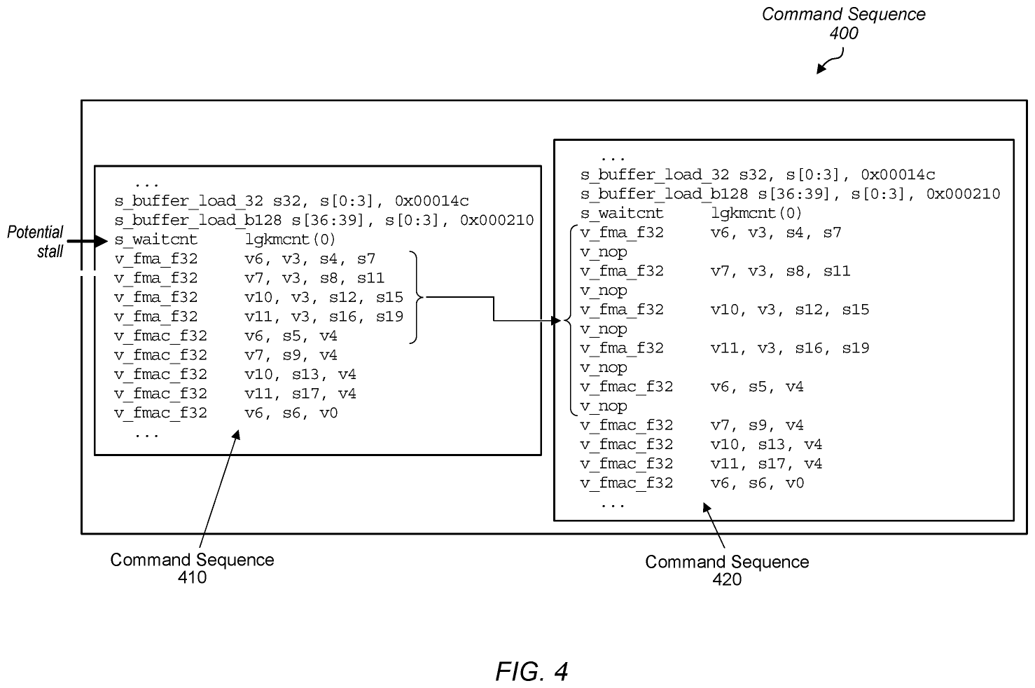

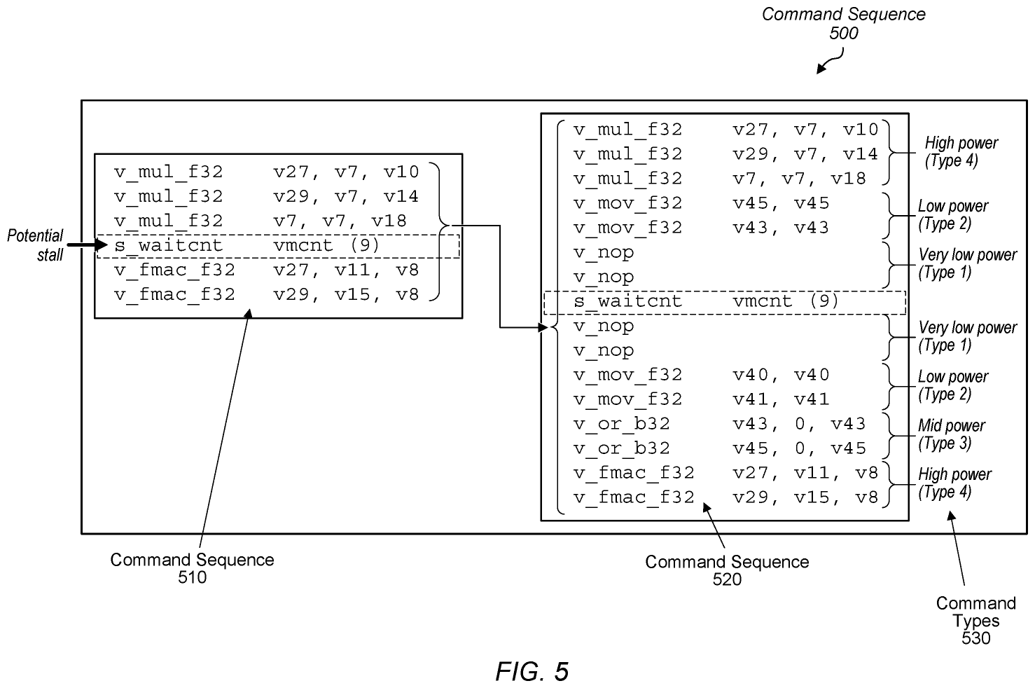

Turning now to FIG. 4 and FIG. 5, generalized block diagrams are shown of command sequences 400 and 500 that illustrate modifications that reduce current transients that cause voltage transients on a power rail of an integrated circuit. The command sequence 420 is a modified version of the command sequence 410. Similarly, the command sequence 520 is a modified version of the command sequence 510. In various implementations, the command sequences 420 and 520 are examples of the modified sequence of instructions 113 (of FIG. 1), that were generated by the circuitry 118 executing the instructions of the current transients mitigator 115. In some implementations, the circuitry of an integrated circuit, such as the circuitry 118, inserts one or more low-power instructions, such as “nop” (no-operation) instructions (or commands), in the commands of the command sequence 410 to generate the command sequence 420.

Each low-power instruction reduces the current transients on a power rail produced by the circuitry that execute the instructions. For example, each nop instruction installs a clock cycle (or a “bubble”) in an execution pipeline of parallel lanes of computation of a highly parallel data processing circuit. The number of inserted nop commands and the placement of these nop commands varies based on an algorithm used by a compiler and executed by the circuitry. Generating the command sequences 420 and 520 reduces an estimated amount of current drawn from or returned to the power rail. As shown, the command sequence 520 includes commands from different command types 530 that correspond to different power bins. Each of the different power bins include commands that provide a different range of power consumption when executed. In the illustrated implementation, the command types 530 include a first power bin includes commands that consume a very low amount of power (Type 1) consumption when executed. Execution of these commands consume an amount of power below a first threshold. An example of these commands is a nop command or instruction.

The command types 530 include a second power bin includes commands that consume a low amount of power (Type 2) consumption when executed. Execution of these commands consume an amount of power above the first threshold and below a second threshold. An example of these commands is a move (“mov”) command or instruction. The command types 530 include a third power bin includes commands that consume a mid (middle) amount of power (Type 3) consumption when executed. Execution of these commands consume an amount of power above the second threshold and below a third threshold. An example of these commands is a Boolean operation command or instruction. The command types 530 also include a fourth power bin includes commands that consume a high amount of power (Type 4) consumption when executed. Execution of these commands consume an amount of power above the third threshold. An example of these commands is a vector arithmetic logic unit (VALU) operation command or instruction such as a vector multiply operation.

In an implementation, when executing the instructions of a current transients mitigator of a compiler, the circuitry modifies the command sequence 510 by inserting one or more commands to generate the command sequence 520. These one or more inserted commands do not change the operating state and consumes a lower amount of power such as an amount of power of a lowest power consuming power bin. One example is a move (“mov”) command that uses a destination operand equal to a source operand such that a data value is read from a particular register and then written back later into the same particular register. Another example of an inserted command is a Boolean OR command with a destination operand identifier being equal to a source operand identifier, and another source operand being a string of zeroes with a data size equal to the other source operand and the destination operand. The command sequence 520 (of FIG. 5) includes such an example of this command. Another example of such a command is a Boolean AND command with a destination operand identifier being equal to a source operand identifier, and another source operand being a string of ones with a data size equal to the other source operand and the destination operand.

Although not shown in the command sequences 400 and 500 (of FIGS. 4 and 5), the control circuitry can also replace one or more operand buffer load or store commands of a region of a command sequence, such as the command sequence 510, with load or store commands that have a smaller data size to generate another command sequence, such as the command sequence 520. The updated operand buffer load or store commands reduce resource contention and remove or at least reduce the resulting stall cycles. In an implementation, the control circuitry selects the regions of the command sequences 410 and 510 for modification as regions immediately prior to or immediately after a wait instruction.

The number of inserted or replaced commands and the placement of these inserted or replaced commands varies based estimations of an amount of current drawn from or returned to a power rail of at least the parallel lanes of computation of a highly parallel data processing circuit. General indications of the estimations 530 are shown for the command sequence 520. By generating the command sequences 420 and 520 and issuing these command sequences 420 and 520 in place of command sequences 410 and 510, the control circuitry adjusts the time rate of change of the current flow being draw from or returned to a particular power rail, and change signal waveforms 210 and 310 (of FIGS. 2-3) to the signal waveforms 220 and 320, respectively.

As described earlier, voltage transients occur when the workload transitions from light to heavy, or vice-versa, in a relatively short amount of time, and no mitigation is performed for the current transients. The voltage transients are caused by the relatively sudden current transients. These events cause the overshoot and undershoot conditions. The above steps performed by the control circuitry to generate and issue the command sequences 420 and 520 more gradually ramps up or ramps down the workload transitions. The gradual changes of the workload transitions cause gradual current transients, which are illustrated in the signal waveforms 200 and 300 (of FIGS. 2 and 3).

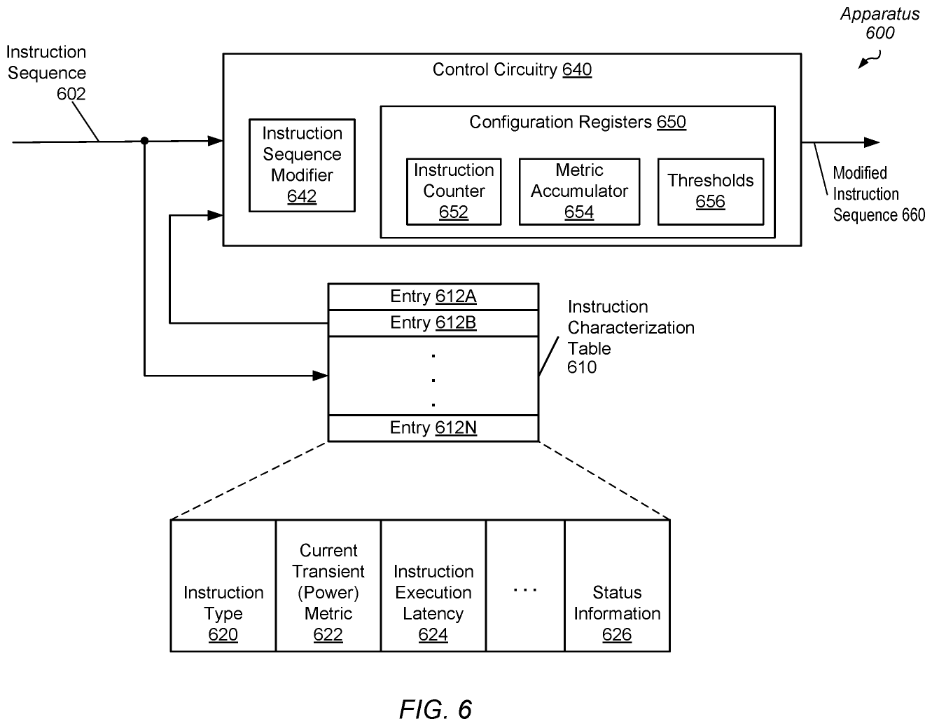

Referring to FIG. 6, a generalized block diagram is shown of an apparatus 600 that mitigates current transients that cause voltage transients on a power rail of an integrated circuit. In the illustrated implementation, the apparatus 600 includes control circuitry 640 and the characterization table 610 (or table 610). The control circuitry 640 receives the instruction sequence 602 and information from the table 610 and generates the modified instruction sequence 660. The control circuitry 640 includes the instruction sequence modifier 642 and the configuration registers 650. The table 610 stores information in the entries 612A-612N. Each of these entries 612A-612N includes the fields 620-626. In various implementations, the functionality provided by the apparatus 600 is also provided by the circuitry 118 of the processing circuit 110 (of FIG. 1). In some implementations, the command sequences 410 and 510 (of FIGS. 4 and 5) are examples of the instruction sequence 602, and the command sequences 420 and 520 (of FIGS. 4 and 5) are examples of the modified instruction sequence 660.

The table 610 is implemented with one of flip-flop circuits, one of a variety of types of a random-access memory (RAM), a content addressable memory (CAM), or other. Although particular information is shown as being stored in the fields 620-626, and in a particular contiguous order, in other implementations, a different order is used and a different number and type of information is stored. The table 610 includes information that characterizes the modification of instruction sequences to mitigate current transients that cause voltage transients on a power rail of an integrated circuit. In some implementations, one of the fields 620-626 stores an indication specifying a particular P-state, and the table 610 is indexed with an opcode of an instruction (or translated command) and a currently used P-state. As used herein, a power-performance state, which is also referred to as a “P-state,” is one of multiple power-performance states that include a set of operational parameters such as an operational clock frequency and an operational power supply voltage. In another implementation, the apparatus 600 has separate characterization tables corresponding to separate supported P-states.

The field 620 stores an indication specifying an instruction type. In an implementation, the instruction type is an opcode of an instruction (or a translated command). An opcode of an instruction indicates an operation to be performed by the instruction, a number of operands to be used by the instruction, and a data size of the operands to be used by the instruction. The field 622 stores an indication specifying a current transient metric or power consumption metric associated with execution of the instruction. An amount of power consumed or an amount of current transients is based on the particular operation of the instruction indicated by its opcode, the accesses of operands (the reading of source operands and the writing of a destination operand), such as operands stored in the vector general-purpose registers (VGPRs), and the operating parameters of processing circuitry such as the compute circuits 104A-104N (of FIG. 1). The operating parameters include the operating clock frequency and the operating power supply voltage level. The estimations (or predictions) of power consumption and/or current transients can be specified by an indication of a power bin.

The field 624 stores an indication specifying a latency associated with execution of the instruction. The instruction sequence modifier 642 can use the latency to identify whether a particular instruction is a wait instruction or another type of high-latency instruction. In some implementations, instruction sequence modifier 642 resets one or more of the instruction counter 652 and the metric accumulator 654 of the configuration registers 650 when a currently evaluated instruction is a low-power and high-latency instruction such as a wait instruction or another type of synchronization instruction. As shown in the command sequences 400 and 500 (of FIGS. 4 and 5), a type of wait instruction is used to synchronize operations. The field 626 stores status information such as at least a valid bit.

When executing instructions of a current transients mitigator of a compiler, the circuitry of the instruction sequence modifier 642 receives an opcode of a particular instruction (or translated command), and information output from the table 610 corresponding to the particular instruction. The instruction sequence modifier 642 updates each of the instruction counter 652 and the metric accumulator 654 of the configuration registers 650 based on at least the information stored in field 622. For example, the updated values of the configuration registers 652 and 654 rely on the current transient metric or power consumption metric associated with execution of the particular instruction.

The instruction sequence modifier 642 modifies a first sequence of instructions (or translated commands) to create a second sequence of instructions (or translated commands) by adding one or more new instructions in the first sequence of instructions. For example, the instruction sequence modifier 642 receives the instruction sequence 602 and generates the modified instruction sequence 660. The instruction sequence modifier 642 performs the modification based on determining that the instruction sequence 602 meets a power related condition. In one implementation, determining that the instruction sequence 602 meets the power related condition includes determining that the instruction sequence 602 includes a count of consecutive high-power instructions that exceeds a count threshold. The count threshold is stored in one of the threshold registers 656. In another implementation, determining that the instruction sequence 602 meets the power related condition includes determining the value stored in the metric accumulator 654 exceeds a threshold. The instruction sequence modifier 642 updates the value stored in the metric accumulator 654 based on the power metric of the instruction stored in field 622 of the table 610.

In an implementation, the instruction sequence modifier 642 generates the modified instruction sequence 660 by inserting, in program order, a low-power instruction after the particular instruction of the instruction sequence 602 being evaluated. The instruction sequence modifier 642 inserts, as the low-power instruction, an instruction with a type associated with low power consumption and does not change program execution state information. For example, the inserted low-power instruction does not change an outcome of an application that includes the instruction sequence 602. In an implementation, the instruction sequence modifier 642 inserts, as the low-power instruction, a nop instruction. In another implementation, the instruction sequence modifier 642 inserts, as the low-power instruction, a move instruction that includes a destination operand that matches a source operand. In yet another an implementation, the instruction sequence modifier 642 inserts, as the low-power instruction, Boolean arithmetic instruction that generates a destination result that matches a value of a source operand. Other examples of low-power instructions to insert that do not change program execution state information are possible and contemplated.

The instruction sequence modifier 642 resets one or more of the values stored in the instruction counter 652 and the metric accumulator 654 of the configuration registers when the instruction sequence modifier 642 reaches a low-power instruction at an end of the instruction sequence 602. In an implementation, when executing instructions of a kernel mode driver (KMD), the instruction sequence modifier 642 assigns state information for a command group that includes at least the modified instruction sequence 660. Examples of the state information are a process identifier (ID), a name of the application or an ID of the application, a version of the application, a compute/graphics type of work, and so on. When executing instructions of the kernel mode driver, the instruction sequence modifier 642 sends the command group and state information to a ring buffer or other memory location.

It is possible and contemplated that one or more of the processing circuits, the compute circuits, and apparatuses illustrated in FIGS. 1 and 6 are implemented as chiplets. As used herein, a “chiplet” is also referred to as an “intellectual property block” (or IP block). However, a “chiplet” is a semiconductor die (or die) fabricated separately from other dies, and then interconnected with these other dies in a single integrated circuit in the MCM. On a single silicon wafer, only multiple chiplets are fabricated as multiple instantiated copies of particular integrated circuitry, rather than fabricated with other functional blocks that do not use an instantiated copy of the particular integrated circuitry. For example, the chiplets are not fabricated on a silicon wafer with various other functional blocks and processors on a larger semiconductor die such as an SoC. A first silicon wafer (or first wafer) is fabricated with multiple instantiated copies of integrated circuitry a first chiplet, and this first wafer is diced using laser cutting techniques to separate the multiple copies of the first chiplet.

A second silicon wafer (or second wafer) is fabricated with multiple instantiated copies of integrated circuitry of a second chiplet, and this second wafer is diced using laser cutting techniques to separate the multiple copies of the second chiplet. The first chiplet provides functionality different from the functionality of the second chiplet. One or more copies of the first chiplet are placed in an integrated circuit, and one or more copies of the second chiplet is placed in the integrated circuit. The first chiplet and the second chiplet are interconnected to one another within a corresponding MCM. Such a process replaces a process that fabricates a third silicon wafer (or third wafer) with multiple copies of a single, monolithic semiconductor die that includes the functionality of the first chiplet and the second chiplet as integrated functional blocks within the single, monolithic semiconductor die.

Process yield of single, monolithic dies on a silicon wafer is lower than process yield of smaller chiplets on a separate silicon wafer. In addition, a semiconductor process can be adapted for the particular type of chiplet being fabricated. With single, monolithic dies, each die on the wafer is formed with the same fabrication process. However, it is possible that an interface functional block does not require process parameters of a semiconductor manufacturer's expensive process that provides the fastest devices and smallest geometric dimensions. With separate chiplets, designers can add or remove chiplets for particular integrated circuits to readily create products for a variety of performance categories. In contrast, an entire new silicon wafer must be fabricated for a different product when single, monolithic dies are used. It is possible and contemplated that one or more of the processing circuits, the compute circuits, and apparatuses illustrated in FIGS. 1 and 6 are implemented as chiplets.

In some implementations, the hardware of the processing circuits and the apparatuses illustrated in FIGS. 1 and 6 is provided in a two-dimensional (2D) integrated circuit (IC) with the dies placed in a 2D package. In other implementations, the hardware is provided in a three-dimensional (3D) stacked integrated circuit (IC). A 3D integrated circuit includes a package substrate with multiple semiconductor dies (or dies) integrated vertically on top of it. Utilizing three-dimensional integrated circuits (3D ICs) further reduces latencies of input/output signals between functional blocks on separate semiconductor dies. It is noted that although the terms “left,” “right,” “horizontal,” “vertical,” “row,” “column,” “top,” and “bottom” are used to describe the hardware, the meaning of the terms can change as the integrated circuits are rotated or flipped.

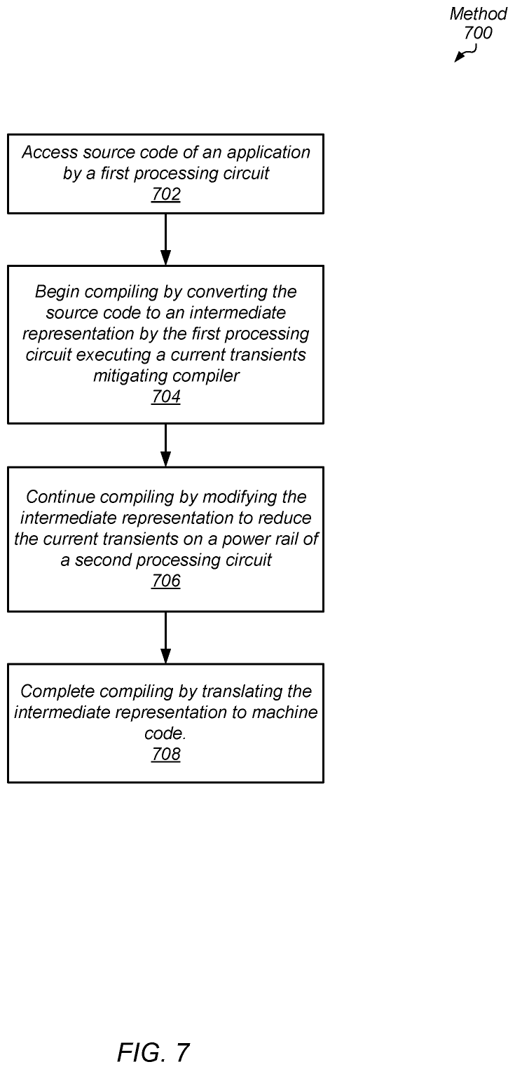

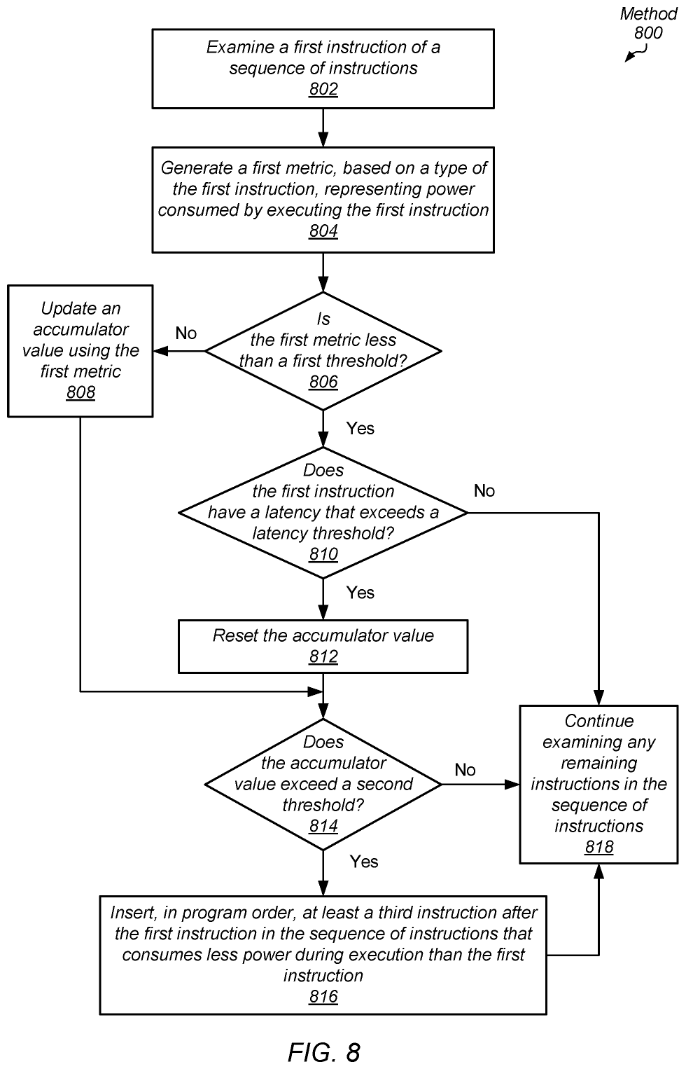

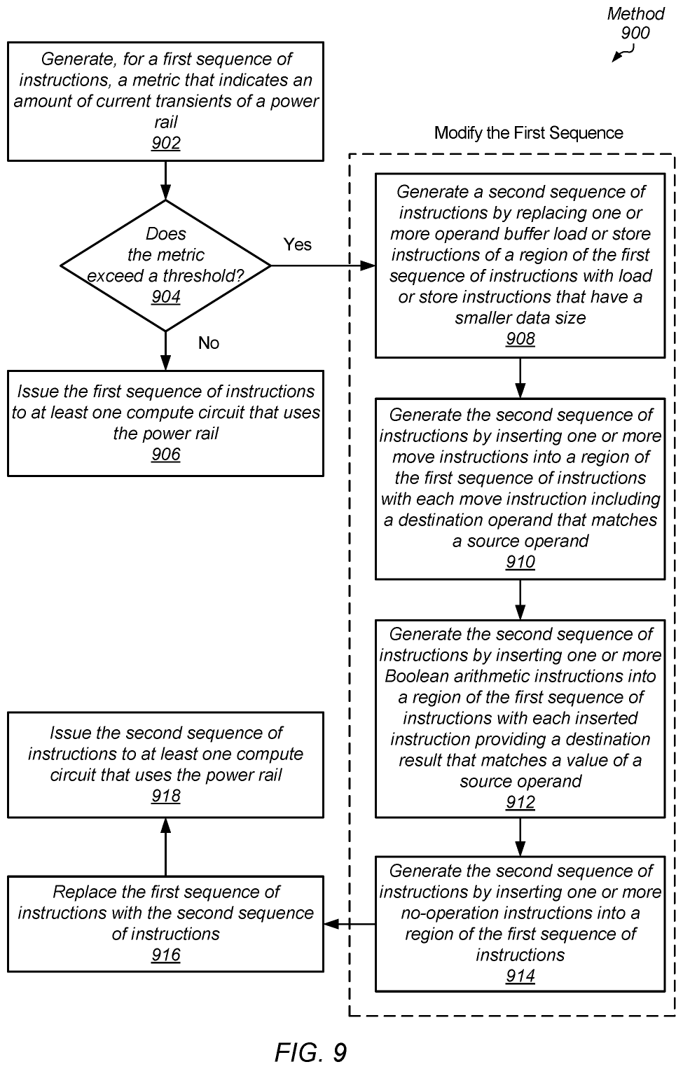

Regarding the methods 700-900 (of FIGS. 7-9), a computing system includes a first processing circuit and a second processing circuit. In some implementations, the first processing circuit has a general-purpose microarchitecture, and the second processing circuit is a parallel data processing circuit with a highly parallel data microarchitecture. The parallel data processing circuit includes multiple, replicated compute circuits, each with the circuitry of multiple lanes of execution. One or more compute circuits use a power rail. In an implementation, the first processing circuit compiles a shader application using a shader compiler, and the second processing circuit executes the translated commands generated by the compilation step. Referring to FIG. 7, a generalized block diagram is shown of a method 700 for mitigating voltage transients on a power rail caused by current transients of an integrated circuit. For purposes of discussion, the steps in this implementation (as well as FIGS. 8-9) are shown in sequential order. However, in other implementations some steps occur in a different order than shown, some steps are performed concurrently, some steps are combined with other steps, and some steps are absent.

The first processing circuit accesses a copy of source code of an application (block 702). One or more designers write software applications in a high-level language such as C, C++, Fortran, or other. When the circuitry of the first processing circuit executes the instructions of an operating system, the circuitry retrieves a copy of the application from system memory and stores the copy in a local hierarchical cache memory subsystem of the first processing circuit. In an implementation, the application is a highly parallel data application, such as a shader application. To compile the source code, a command with any necessary options is executed. The command can be entered at a prompt by a user or placed within a scripting language.

When the circuitry of the first processing circuit executes the instructions of a compiler, the first processing circuit begins compiling the application by converting the source code to an intermediate representation (block 704). In various implementations, the compiler includes instructions of an algorithm that implements a current transients mitigator. In some implementations, the compiler is a shader compiler. When the circuitry of the first processing circuit executes the instructions of a compiler, the first processing circuit performs syntactic and semantic processing as well as some optimizations. In an implementation, this compilation step is completely static, and the lower-level representation is an output of a front-end phase to be further compiled statically into machine code. In another implementation, this compilation step is static upfront where the lower-level representation is bytecode to be further compiled dynamically into machine code by the circuitry executing the instructions of a JIT compiler within a virtual machine.

When the circuitry of the first processing circuit executes the instructions of a compiler, the first processing circuit continues compiling by modifying the intermediate representation to reduce the current transients on a power rail of the second processing circuit (block 706). For example, the first processing circuit modifies the machine code in a similar manner as shown earlier to modify the command sequences 410 and 510 (of FIGS. 4-5) to the command sequences 420 and 520. By generating modified command sequences in the machine code, such as the command sequences 420 and 520, the first processing circuit adjusts the time rate of change of the current flow corresponding to a particular power rail used by one or more compute circuits of the second processing circuit, and change signal waveforms 210 and 310 (of FIGS. 2-3) to the signal waveforms 220 and 320, respectively.

When the circuitry of the first processing circuit executes the instructions of a compiler, the first processing circuit completes compiling by translating the intermediate representation to machine code (block 708). The first processing circuit performs more transformations and optimizations for a particular computer architecture and processing circuit design. For example, the first processing circuit generates at least a portion of the machine code for execution by the second processing circuit. The way the machine code is executed to reach peak performance differs greatly based on the particular hardware configuration of the second processing circuit. As described earlier, the first processing circuit uses libraries with their own application program interfaces (APIs).

Referring to FIG. 8, a generalized block diagram is shown of a method 800 for efficiently managing voltage transients on a power rail caused by current transients of an integrated circuit. When the circuitry of the first processing circuit executes the instructions of a compiler, the first processing circuit examines a first instruction of a sequence of instructions (block 802). The first processing circuit generates a first metric, based on at least a type of the first instruction, representing power consumed by executing the first instruction (block 804). In some implementations, the first processing circuit includes circuitry similar to the apparatus 600 that determines the first metric based on one or more of the opcode of the first instruction, a currently used P-state, a measured operating temperature, and so forth.

If the metric does not exceed a first threshold (“no” branch of the conditional block 806), then the first processing circuit updates an accumulator value using the first metric (block 808). Afterward, control flow of method 800 moves to conditional block 814. If the metric exceeds the first threshold (“yes” branch of the conditional block 806), but if the first instruction has a latency that does not exceed a latency threshold (“no” branch of the conditional block 810), then the first processing circuit continues examining any remaining instructions in the sequence of instructions (block 818).

If the metric exceeds the first threshold (“yes” branch of the conditional block 806), and if the first instruction has a latency that exceeds the latency threshold (“yes” branch of the conditional block 810), then the first processing circuit resets the accumulator value (block 812). If the accumulator value does not exceed a second threshold (“no” branch of the conditional block 814), then first processing circuit continues examining any remaining instructions in the sequence of instructions (block 818). Otherwise, if the accumulator value exceeds the second threshold (“yes” branch of the conditional block 814), then the first processing circuit inserts, in program order, at least a third instruction after the first instruction in the sequence of instructions that consumes less power during execution than the first instruction (block 816). Additionally, execution of the third instruction does not change program execution state information. One example of the third instruction is a nop instruction.

Referring to FIG. 9, a generalized block diagram is shown of a method 900 for efficiently managing voltage transients on a power rail caused by current transients of an integrated circuit. The first processing circuit generates, for a first sequence of instructions, a metric that indicates an amount of current transients of a power rail (block 902). If the metric does not exceed a threshold (“no” branch of the conditional block 904), then the first processing circuit sends the first sequence of instructions to the second processing circuit, and a scheduler issues the first sequence of instructions to at least one compute circuit of the second processing circuit that uses the power rail (block 906).

If the metric exceeds a threshold (“yes” branch of the conditional block 904), then the first processing circuit generates a second sequence of instructions that provides a lower estimate by replacing one or more operand buffer load or store commands of a region of the first sequence of instructions with load or store commands that have a smaller data size (block 908).

The circuitry generates the second sequence of instructions by inserting one or more move commands into a region of the first sequence of instructions with each move command including a destination operand that matches a source operand (block 910). The circuitry generates the second sequence of instructions by inserting one or more Boolean arithmetic commands into a region of the first sequence of instructions with each inserted command providing a destination result that matches a value of a source operand (block 912). An example of such a command is a Boolean OR command with a destination operand identifier being equal to a source operand identifier, and another source operand being a string of zeroes with a data size equal to the other source operand and the destination operand. The command sequence 520 (of FIG. 5) includes such an example of this command. Another example of such a command is a Boolean AND command with a destination operand identifier being equal to a source operand identifier, and another source operand being a string of ones with a data size equal to the other source operand and the destination operand.

The circuitry generates the second sequence of instructions by inserting one or more no-operation (nop) instructions into a region of the first sequence of instructions (block 914). Each of the instruction types inserted into a region of the first sequence of instructions in the above blocks 908-914 is a low-power instruction that also doesn't change program execution state information. The first processing circuit replaces the first sequence of instructions with the second sequence of instructions (block 916). The first processing circuit sends the second sequence of instructions to the second processing circuit, and a scheduler issues the second sequence of instructions to at least one compute circuit of the second processing circuit that uses the power rail (block 918).

In some implementations, the first processing circuit inserts instructions of less than the different instruction types described for the above blocks 908-914. In another implementation, the first processing circuit inserts another instruction type not included in the different instruction types described for the above blocks 908-914. For example, the first processing circuit inserts a low-power instruction that generates arbitrary results to be stored in a register that is not used elsewhere in the application. In some implementations, the first processing circuit inserts instructions in a ramp-up or a ramp-down manner. An example of a ramp-up manner is inserting one or more very low-power instructions followed by inserting, in program order, one or more low-power instructions, followed by inserting, in program order, one or more mid-power instructions, and followed by inserting, in program order, one or more high-power instructions. The ramp-down manner would reverse the order of inserting instructions.

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. A non-transitory computer readable medium comprising program instructions executable by circuitry to:
receive a first sequence of instructions of program instructions;
modify the first sequence of instructions to create a second sequence of instructions by adding one or more new instructions in the first sequence of instructions, in response to the first sequence of instructions meeting a power related condition; and
compile the second sequence of instructions into machine executable code for execution by processing circuitry.

2. The non-transitory computer readable medium as recited in claim 1, wherein the first sequence of instructions meeting the power related condition comprises the first sequence of instructions including a count of consecutive high-power instructions that exceeds a threshold.

3. The non-transitory computer readable medium as recited in claim 2, wherein the first sequence of instructions corresponds to a shader program and the processing circuitry is shader processing circuitry.

4. The non-transitory computer readable medium as recited in claim 2, wherein to modify the first sequence of instructions, the program instructions are executable by circuitry to insert, in program order, a low-power instruction after the first sequence of instructions.

5. The non-transitory computer readable medium as recited in claim 4, wherein the program instructions are executable by circuitry to reset the count, in response to reaching a low-power instruction at an end of the first sequence of instructions.

6. The non-transitory computer readable medium as recited in claim 4, wherein the program instructions are executable by circuitry to insert, as the low-power instruction, an instruction with a type associated with low power consumption and does not change program execution state information.

7. The non-transitory computer readable medium as recited in claim 4, wherein the program instructions are executable by circuitry to insert, as the low-power instruction, a move instruction comprising a destination operand that matches a source operand.

8. A method, comprising:
receiving, by circuitry of a processing circuit, a first sequence of instructions of program instructions;
modifying, by the circuitry, the first sequence of instructions to create a second sequence of instructions by adding one or more new instructions in the first sequence of instructions, in response to the first sequence of instructions meeting a power related condition; and
compiling, by the circuitry, the second sequence of instructions into machine executable code for execution by processing circuitry.

9. The method as recited in claim 8, further comprising determining, by the circuitry, the first sequence of instructions meets the power related condition based on the first sequence of instructions includes a count of consecutive high-power instructions that exceeds a threshold.

10. The method as recited in claim 9, further comprising:
modifying, by the circuitry, the first sequence of instructions that are instructions corresponds to a shader program; and
compiling the second sequence of instructions by processing circuitry that is shader processing circuitry.

11. The method as recited in claim 9, wherein modifying the first sequence of instructions comprises inserting, in program order by the circuitry, a low-power instruction after the first sequence of instructions.

12. The method as recited in claim 11, further comprising resetting the count by the circuitry, in response to reaching a low-power instruction at an end of the first sequence of instructions.

13. The method as recited in claim 11, further comprising inserting, as the low-power instruction by the circuitry, an instruction with a type associated with low power consumption and does not change program execution state information.

14. The method as recited in claim 11, further comprising inserting, as the low-power instruction by the circuitry, a Boolean arithmetic instruction that generates a destination result that matches a value of a source operand.

15. An apparatus comprising:
circuitry configured to:
receive a first sequence of instructions of program instructions;
modify the first sequence of instructions to create a second sequence of instructions by adding one or more new instructions in the first sequence of instructions, in response to the first sequence of instructions meeting a power related condition; and
compile the second sequence of instructions into machine executable code for execution by processing circuitry.

16. The apparatus as recited in claim 15, wherein the first sequence of instructions meeting the power related condition comprises the first sequence of instructions including a count of consecutive high-power instructions that exceeds a threshold.

17. The apparatus as recited in claim 16, wherein the first sequence of instructions corresponds to a shader program and the processing circuitry is shader processing circuitry.

18. The apparatus as recited in claim 16, wherein to modify the first sequence of instructions, the program instructions are executable by circuitry to insert, in program order, a low-power instruction after the first sequence of instructions.

19. The apparatus as recited in claim 18, wherein the program instructions are executable by circuitry to reset the count, in response to reaching a low-power instruction at an end of the first sequence of instructions.

20. The apparatus as recited in claim 18, wherein the program instructions are executable by circuitry to insert, as the low-power instruction, an instruction with a type associated with low power consumption and does not change program execution state information.
